(19) United States
(12) Patent Application Publication
(10) Pub. No.: US 2026/0126080 A1
(43) Pub. Date: May 7, 2026

(54) Pin Bushing and Method of Manufacturing the Same

(71) Applicant: Caterpillar Inc., Peoria, IL (US)

(72) Inventors: Baojie AI, Tianjin (CN); Pai PENG, Xuzhou City (CN); Kun YAN, Xuzhou City (CN); Guozhi XIAN, Tianjin (CN)

(73) Assignee: Caterpillar Inc., Peoria, IL (US)

(21) Appl. No.: 19/118,998

(22) PCT Filed: Sep. 28, 2023
(86) PCT No.: PCT/US2023/075363

§ 371 Date: Apr. 7, 2025

(30) Foreign Application Priority Data
Oct. 12, 2022 (CN) 202211248381.6

(51) Int. Cl. F16C 33/12; F16C 33/14

(52) U.S. Cl. CPC F16C 33/121; F16C 33/14; F16C 2202/04; F16C 2204/60; F16C 2223/18; F16C 2350/26

(57) ABSTRACT

The present disclosure provides a pin bushing and a method of manufacturing the same. The pin bushing comprises a first axial section, a second axial section and an intermediate section, the first axial section and the second axial section are located at both ends of the pin bushing in the axial direction, the intermediate section is disposed between the first axial section and the second axial section, the intermediate section has an intermediate radially outer portion and an intermediate radially inner portion, and hardness values of the first axial section, the second axial section and the intermediate radially outer portion are greater than that of the intermediate radially inner portion.

### FIELD

The present disclosure relates to a track pin bushing for used in the field of construction machinery, and particularly to a pin bushing and a method of manufacturing the same.

### BACKGROUND

Construction machineries such as excavators and bulldozers are usually provided with a track. A typical track design comprises a sprocket for driving the track, a pin and a pin bushing disposed around the pin, etc. An outer circumferential surface of the pin bushing is often subject to wear because the outer circumferential surface needs to engage the sprocket and both ends of the inner circumferential surface need to engage the pin. In order to increase the service life of the pin bushing, the pin bushing is typically heat-treated during its manufacture to increase its hardness and wear resistance. However, in conventional heat treatment processes, the steps are cumbersome, energy consumption is large, and the costs are high.

Accordingly, it is desirable to provide a pin bushing and a method of manufacturing the same, to at least partially address the above problems.

### SUMMARY

An object of the present disclosure is to provide a pin bushing and a method of manufacturing the same, which can simplify the operation steps and reduce the costs while ensuring the hardness of the pin bushing.

According to an aspect of the present disclosure, there is provided a pin bushing, comprising a through-hole running through the pin bushing in an axial direction of the pin bushing, a first axial section, a second axial section and an intermediate section disposed around the through-hole. The first axial section and the second axial section are located at both ends of the pin bushing in the axial direction, and the intermediate section is disposed between the first axial section and the second axial section. The intermediate section has an intermediate radially outer portion and an intermediate radially inner portion in a radial direction of the pin bushing, wherein the intermediate radially inner portion has a radially inward surface, and the radially inward surface encloses a portion of the through-hole. Wherein hardness values of the first axial section, the second axial section and the intermediate radially outer portion are greater than that of the intermediate radially inner portion.

According to another aspect of the present disclosure, there is provided a method of manufacturing the above-mentioned pin bushing, the manufacturing method comprising the following steps of:
preliminarily forming the pin bushing;
performing induction heating on the preliminarily-formed pin bushing, the step further comprising:
moving an induction coil in the axial direction of the pin bushing;
adjusting at least one of a feeding rate, an output power and an induction frequency of the induction coil depending on a relative position between the induction coil and the pin bushing such that the first axial section and the second axial section are heated entirely from outside to inside in the radial direction of the pin bushing, the intermediate radially outer portion is heated, and the intermediate radially inner portion is not heated or is heated to a lesser extent than the intermediate radially outer portion; and
cooling and quenching the first axial section and second axial section and the intermediate radially outer portion.

According to the above-mentioned solution, a high hardness of the intermediate radially outer portion and the entirety of both ends of the pin bushing, and a relatively low hardness of the intermediate radially inner portion of the pin bushing may be achieved by performing only one heating operation of the induction heating apparatus, so that both ends and the intermediate radially outer portion of the pin bushing may have a superior wear resistance, and the intermediate radially inner portion has a better impact resistance and fatigue life, enabling the pin bushing to be well adapted for application conditions of medium-sized excavators. In addition, the solution can simplify the operation steps, significantly reduce costs and save manpower and material resources.

### BRIEF DESCRIPTION OF THE DRAWINGS

Reference may be made to preferred embodiments shown in the figures to enable better understanding of the above and other objects, features, advantages and functions of the present disclosure. The same reference numerals in the figures denote the same parts. Those skilled in the art should appreciate that the figures are intended to schematically illustrate the preferred embodiments of the present disclosure, and not intended to impose any limitations to the scope of the present disclosure. All parts in the figures are not drawn to scale.

FIG. 1 shows a cross-sectional view of a pin bushing according to some preferred embodiments of the present disclosure.

FIG. 2 shows a flow chart of a method of manufacturing a pin bushing according to some preferred embodiments of the present disclosure.

### DETAILED DESCRIPTION OF EMBODIMENTS

Specific embodiments of the present disclosure will now be described in detail with reference to the figures. What are described herein are only preferred embodiments of the present disclosure. Those skilled in the art may implement other manners of the present disclosure on the basis of the preferred embodiments, and said other manners also fall within the scope of the present disclosure.

First, it should be appreciated that directional terms and positional terms in the present disclosure should be understood as relative direction and position rather than absolute direction and position.

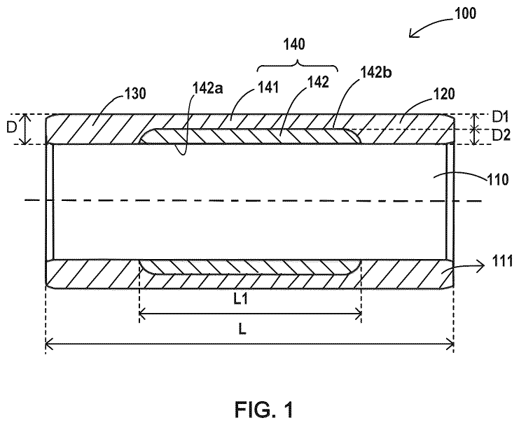

FIG. 1 is a cross-sectional view of a pin bushing 100 according to a preferred embodiment of the present disclosure. The pin bushing may be used for a track of a construction machinery. Generally, outer surfaces of both ends of the pin bushing each engage with a chain rail joint, inner surfaces of both ends of the pin bushing engage with a pin shaft, and an outer surface of a middle portion of the pin bushing engages with a drive sprocket in the track. For example, the construction machinery may be any on-highway (such as a bulldozer, excavator, etc.) vehicle or off-highway vehicle. The pin bushing according to the preferred embodiment of the present disclosure is particularly adapted for use in medium-sized excavators.

As shown in FIG. 1, the pin bushing 100 is generally configured in a hollow cylindrical shape, and comprises a through-hole 110 running through in an axial direction thereof, and the through-hole 110 has a substantially uniform inner diameter in the axial direction, that is, the inner surface of the pin bushing 100 is cylindrical. Preferably, the outer surface of the pin bushing 100 is also generally constructed as a cylindrical shape. Furthermore, the pin bushing 100 comprises a first axial section 120, a second axial section 130, and an intermediate section 140 disposed around the through-bore. The first axial section 120 and the second axial section 130 are located at both ends of the pin bushing 100 in the axial direction, and the intermediate section 140 is disposed between the first axial section 120 and the second axial section 130. The first axial section 120, the second axial section 130 and the intermediate section 140 each have a certain length in the axial direction of the pin bushing 100 and a certain thickness in a radial direction of the pin bushing 100. Preferably, the pin bushing 100 is an integrally-formed unitary piece.

In a preferred embodiment, the pin bushing 100 is made of a carbon steel material. Further preferably, the pin bushing 100 may be made of a low alloy medium carbon steel material.

With further reference to FIG. 1, the intermediate section 140 has an intermediate radially outer portion 141 and an intermediate radially inner portion 142; in the radial direction of the pin bushing 100, the intermediate radially inner portion 142 is located radially inward of the pin bushing 100 relative to the intermediate radially outer portion 141, and the intermediate radially inner portion 142 is adjacent to the through-hole 110. The intermediate radially inner portion 142 has a radially inward surface 142a and a radially outward surface 142b opposite to the radially inward surface 142a in the radial direction, the radially inward surface 142a enclosing a portion of the through-hole 110. The intermediate radially inner portion 142 has a certain length in the axial direction and a certain depth in the radial direction. Both ends of the intermediate radially inner portion 142 have rounded corners. In a preferred embodiment, a depth D2 of the intermediate radially inner portion 142 is in a range of 60%-40% of an overall wall thickness D of the pin bushing 100, and a depth D1 of the intermediate radially outer portion 141 is in a range of 40%-60% of the overall wall thickness D of the pin bushing 100. For example, the depth D2 of the intermediate radially inner portion 142 may be set to 55% of the overall wall thickness D of the pin bushing 100 and the depth D1 of the intermediate radially outer portion 141 may be set to 45% of the overall wall thickness D of the pin bushing 100; alternatively, the intermediate radially outer portion 141 and the intermediate radially inner portion 142 may be set to have the same depth. Preferably, an axial length L1 of the intermediate radially inner portion 142 is in a range of 40%-60% of an overall axial length L of the pin bushing 100. For example, the axial length L1 of the intermediate radially inner portion 142 may be set to 40%, 50%, or 60% of the overall axial length L of the pin bushing 100. Those skilled in the art may set the values according to actual needs.

Hardness values of the intermediate radially outer portion 141 and the intermediate radially inner portion 142 are different. The hardness value of the intermediate radially outer portion 141 is greater than that of the intermediate radially inner portion 142, and furthermore, the hardness values of the first axial section 120 and the second axial section 130 are greater than that of the intermediate radially inner portion 142. It should be noted that “hardness values of the first axial section 120 and the second axial section 130” mentioned in the text herein refer to overall hardness of the first axial section 120 and the second axial section 130 from its inner diameter to its outer diameter. That is, the hardness values of portions of the first axial section 120 from one end of the first axial section 120 to the other end of the first axial section 120 in the axial direction and the hardness values of the portions of the first axial section 120 from inside to outside in the radial direction are all greater than that of the intermediate radially inner portion 142, and the hardness values of portions of the second axial section 130 from one end of the second axial section 130 to the other end of the second axial section 130 in the axial direction and the hardness values of the portions of the second axial section 130 from inside to outside in the radial direction are all greater than that of the intermediate radially inner portion 142.

Preferably, the hardness values of the first axial section 120 and the second axial section 130 are the same, and the hardness values of the first axial section 120 and the second axial section 130 are the same as that of the intermediate radially outer portion 141. This solution may simplify a process of hardening the pin bushing 100. It will be appreciated by those skilled in the art that the hardness values of the first axial section 120, the second axial section 130 and the intermediate radially outer portion 141 may also be set to be different as actually needed.

Preferably, the hardness values of the first axial section 120, the second axial section 130 and the intermediate radially outer portion 141 are in a range of HRC 55-HRC 60, and the hardness value of the intermediate radially inner portion 142 is less than or equal to HRC 35. Exemplarily, the hardness values of the first axial section 120, the second axial section 130 and the intermediate radially outer portion 141 may be set to HRC 55, HRC 56, HRC 58, or the like. The hardness value of the intermediate radially inner portion 142 may be set to HRC 34, HRC 30 or the like. In a preferred embodiment, the structure of the first axial section 120, the second axial section 130 and the intermediate radially outer portion 141 is martensite and a structure of the intermediate radially inner portion 142 is pearlite and ferrite.

With the above arrangements, entirety of both ends of the pin bushing 100 have a high hardness, and the intermediate radially outer portion 141 of the pin bushing 100 has a high hardness, so that both ends of the pin bushing 100 and the intermediate radially outer portion all have a superior wear resistance, and thus the service life can be improved. The intermediate radially inner portion 142 of the pin bushing 100 is relatively soft and thus has better impact resistance and fatigue life, enabling the pin bushing to be well adapted for application conditions of medium-sized excavators.

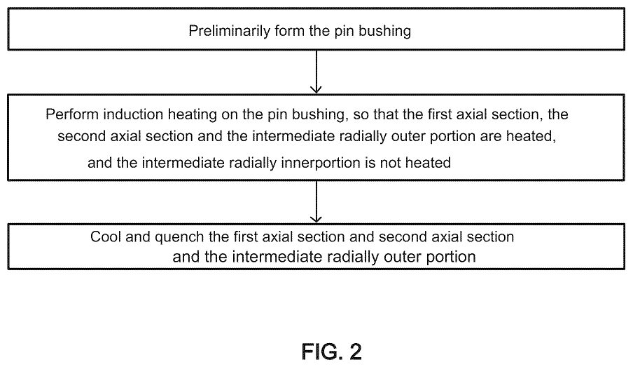

A method of manufacturing the pin bushing 100 according to a preferred embodiment of the present disclosure is described below with reference to FIG. 2.

As shown in FIG. 2, in a preferred embodiment, the method of manufacturing the pin bushing 100 comprises:
first, preliminarily forming the pin bushing 100, wherein the preliminarily-formed pin bushing 100 refers to a pin bushing before a heat treatment process is performed; a process of preliminarily forming the pin bushing 100 may be performed according to a method known in the art, and will not be described in detail herein. The preliminarily-formed pin bushing 100 is already substantially formed with a hollow cylindrical shape.

Next, performing induction heating on the preliminarily-formed pin bushing 100. The step further comprises: enabling the pin bushing 100 to pass through an induction coil of an induction heating apparatus. The induction heating apparatus may be a medium frequency induction heating apparatus with a servo motor feeding device. The induction coil is then moved in the axial direction of the pin bushing 100, and at least one of a feeding rate, an output power and an induction frequency of the induction coil is adjusted depending on a relative position between the induction coil and the pin bushing 100 to control the distribution of the hardness of the pin bushing 100 in the radial direction. Preferably, the operation may be performed in such a manner that the adjustment of the feeding rate of the induction coil is combined with the adjustment of the output power.

Preferably, the feeding rate of the induction coil at the first axial section 120 and the second axial section 130 is less than that of the induction coil at the intermediate section 140, and the output power of the induction coil at the first axial section 120 and the second axial section 130 is greater than that of the induction coil at the intermediate section 140, such that the first axial section 120 and the second axial section 130 may be heated entirely from outside to inside in the radial direction of the pin bushing 100, the intermediate radially outer portion 141 may be heated, and the intermediate radially inner portion 142 may not be heated. It should be appreciated that the embodiment in which the intermediate radial inner portion 142 is not heated is a preferred embodiment of the present disclosure, but it may be understood that the intermediate radial inner portion 142 might also be slightly heated during the actual heat treatment. This solution also falls within the scope of the present disclosure. With the solution described above, the first axial section 120 and the second axial section 130 of the pin bushing 100 after the heat treatment entirely have an austenitic structure, and the intermediate radially outer portion 141 also has an austenitic structure, whereas the unheated or slightly-heated intermediate radially inner portion 142 has a pearlite plus ferrite structure.

Preferably, the feeding rate of the induction coil at the intermediate section 140 is 2-2.5 times that of the induction coil at the first axial section 120 and the second axial section 130, and the output power of the induction coil at the first axial section 120 and the second axial section 130 is 1.1-1.5 times that of the induction coil at the intermediate section 140. Further preferably, the feeding rate of the induction coil at the first axial section 120 and the second axial section 130 is 4-8 mm/s and the output power is 250-350 kW. The feeding rate of the induction coil at the intermediate section 140 is 12-16 mm/s, and the output power of the induction coil at the first axial section 120 and the second axial section 130 is 210-310 kW.

In other embodiments, the distribution of the hardness of the pin bushing 100 in the radial direction may also be adjusted by changing the induction frequency of the induction heating apparatus. Preferably, the induction frequency of the induction coil at the first axial section 120 and the second axial section 130 may be lower than that of the induction coil at the intermediate section 140, such that the first axial section 120 and the second axial section 130 may be heated entirely from outside to inside along the radial direction of the pin bushing 100, the intermediate radially outer section 141 may be heated, and the intermediate radially inner section 142 may not be heated or may be heated only slightly.

Preferably, the first axial section 120 and the second axial section 130 of the pin bushing 100 are heated at a temperature in a range of 900° C.-950 ° C. for 5 to 6 seconds for each of the first axial section 120 and the second axial section 130, and the intermediate section 140 is heated at a temperature in a range of 900° C.-950 ° C. for 8 to 10 seconds.

The first axial section 120 and second axial section 130 and the intermediate radially outer portion 141 may then be cooled and quenched. By way of example, the cooling may be performed by spraying water at a high pressure. Alternatively, other cooling media, such as oil, may be used for the quenching process, or a proportion of quench liquid may be added to the water. Those skilled in the art may set this according to actual needs.

After cooling and quenching, the structure of the first axial section 120, the second axial section 130 and the intermediate radially outer portion 141 may transform to martensite, whereas the intermediate radially inner portion 142 may maintain the original substrate soft tissue, i.e., pearlite and ferrite.

### INDUSTRIAL APPLICABILITY

With the above arrangement, entirety of both ends of the pin bushing 100 have a high hardness, the intermediate radially outer portion 141 of the pin bushing 100 also has a high hardness, and the intermediate radially inner portion 142 of the pin bushing 100 is relatively soft. This solution allows the pin bushing 100 to have a superior wear resistance at both its ends and the intermediate radially outer part 141 during operation, so that the service life may be improved, and the intermediate radially inner portion has a better impact resistance and fatigue life. The pin bushing according to the above solution may reduce the frequency of maintenance and repair, and can generally reduce the maintenance cost of the construction machinery using the pin bushing, and improve the user's experience.

In addition, according to the above solution, the induction heating apparatus may achieve a high hardness of the intermediate radially outer portion 141 and the entirety of both ends of the pin bushing 100, and a low hardness of the intermediate radially inner portion 142 of the pin bushing 100 by performing only one heating operation. This solution can simplify the operation steps and reduce the cost on the premise of ensuring the distribution of hardness of the pin bushing.

The above depictions of various embodiments of the present disclosure are provided to those having ordinary skill in the art for depiction purpose, and are not intended to exclude other embodiments from the present disclosure or limit the present disclosure to a single disclosed embodiment. As described above, various alternatives and modifications of the present disclosure will be apparent to those of ordinary skill in the art. Accordingly, although some alternative embodiments have been described in detail, those having ordinary skill in the art will understand or readily develop other embodiments. The present disclosure is intended to include all alternatives, modifications and variations of the present disclosure described herein, as well as other embodiments falling within the spirit and scope of the present disclosure described herein.

1. A pin bushing, wherein the pin bushing comprises a through-hole running through the pin bushing in an axial direction of the pin bushing, a first axial section, a second axial section and an intermediate section disposed around the through-hole, the first axial section and the second axial section are located at both ends of the pin bushing in the axial direction, the intermediate section is disposed between the first axial section and the second axial section, the intermediate section has an intermediate radially outer portion and an intermediate radially inner portion in a radial direction of the pin bushing, the intermediate radially inner portion has a radially inward surface, the radially inward surface encloses a portion of the through-hole, wherein hardness values of the first axial section, the second axial section and the intermediate radially outer portion are greater than that of the intermediate radially inner portion.

2. The pin bushing according to claim 1, wherein the pin bushing is made of a carbon steel material.

3. The pin bushing according to claim 1, wherein a structure of the first axial section, the second axial section, and the intermediate radially outer portion is martensitic, and a structure of the intermediate radially inner portion is pearlite and ferrite.

4. The pin bushing according to claim 1, wherein a shape of the pin bushing satisfies at least one of the following: an outer surface of the pin bushing is cylindrical and an inner surface of the pin bushing is cylindrical.

5. The pin bushing according to claim 4, wherein a depth of each portion of the intermediate section satisfies at least one of: a depth of the intermediate radially outer portion is in a range of 40%-60% of an overall wall thickness of the pin bushing, and a depth of the intermediate radially inner portion is in a range of 60%-40% of the overall wall thickness of the pin bushing.

6. The pin bushing according to claim 5, wherein an axial length of the intermediate radially inner portion is in a range of 40%-60% of an overall axial length of the pin bushing.

7. The pin bushing according to claim 6, wherein the intermediate radially inner portion has rounded corners at both ends in the axial direction.

8. The pin bushing according to claim 1, wherein hardness values of portions of the first axial section in the radial direction are all greater than that of the intermediate radially inner portion, and hardness values of portions of the second axial section in the radial direction are all greater than that of the intermediate radially inner portion.

9. The pin bushing according to claim 8, wherein the hardness values of the first axial section, the second axial section and the intermediate radially outer portion are in a range of HRC55-HRC60, and the hardness value of the intermediate radially inner portion is less than or equal to HRC35.

10. The method of manufacturing the pin bushing according to claim 1, wherein the method comprises the following steps of:
preliminarily forming the pin bushing;
performing induction heating on the preliminarily-formed pin bushing, the step further comprising:
moving an induction coil in the axial direction of the pin bushing;
adjusting at least one of a feeding rate, an output power and an induction frequency of the induction coil depending on a relative position between the induction coil and the pin bushing such that the first axial section and the second axial section are heated entirely from outside to inside in the radial direction of the pin bushing, the intermediate radially outer portion is heated, and the intermediate radially inner portion is not heated or is heated to a lesser extent than the intermediate radially outer portion; and
cooling and quenching the first axial section and second axial section and the intermediate radially outer portion.

11. The method according to claim 10, wherein the feeding rate of the induction coil at the first axial section and the second axial section is less than that of the induction coil at the intermediate section.

12. The method according to claim 10, wherein the output power of the induction coil at the first axial section and the second axial section is greater than that of the induction coil at the intermediate section.

13. The method according to claim 10, wherein the induction frequency of the induction coil at the first axial section and the second axial section is lower than that of the induction coil at the intermediate section.

14. The method according to claim 11, wherein the feeding rate of the induction coil at the intermediate section is 2-2.5 times that of the induction coil at the first axial section and the second axial section.

15. The method according to claim 12, wherein the output power of the induction coil at the first axial section and the second axial section is 1.1-1.5 times that of the induction coil at the intermediate section.
